(19) United States
(12) Patent Application Publication
(10) Pub. No.: US 2002/0010630 A1
(43) Pub. Date: Jan. 24, 2002

(54) Information providing system and method thereof

(75) Inventor: Nobuhiko Kitamura, Oomiya-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 09/904,843

(22) Filed: Jul. 16, 2001

(30) Foreign Application Priority Data
Apr. 17, 2001 (JP) 2001-118289
Jul. 21, 2000 (JP) 2000-220241

(51) Int. Cl. G06F 17/60

(52) U.S. Cl. 705/14

(57) ABSTRACT

An advertisement provider transmits advertising data to, for example, a WWW (World Wide Web) server from a terminal and the WWW server transmits the advertising data to a user terminal through a communication network such as the Internet. Advertisement charges to the advertisement provider are changed according to transmitting time period, and charges to the user are changed according to the transmitting time period. The advertisement charges or the user charges may be increased or decreased according to the number of accesses.

### INCORPORATION BY REFERENCE

This disclosures of Japanese Patent Applications No. 2000-220241filed on Jul. 21, 2000 and 2001-118289 filed on Apr. 17, 2001, including the specifications and abstracts are incorporated herein by reference in their entirety.

### BACKGROUND OF THE INVENTION

1. Field of Invention

The invention relates to an information providing system and a method thereof, particularly provision of advertising information.

2. Description of Related Art

With advancement of communication infrastructure such as the Internet, technologies for providing advertising information through the Internet have been developed.

For example, a technology exists for appending advertising information called a banner to a predetermined position on a web page and displaying it on a user terminal.

Moreover, Japanese Patent Laid-Open Publication No. 11(1999)296540 describes a technology in which map data and advertising information are stored, and when a user designates desired positional information on the map from a terminal, the advertising information corresponding to that position is transmitted to the user terminal. Thereby, it is possible to efficiently provide an advertisement related to an area of the user's interest. Moreover, it is described that a plurality of advertisements corresponding to respective areas are prepared and displayed with altered contents according to a time period.

However, in a case where an advertisement is placed on a web page, advertisement charges are determined only according to the kind of the placed web page or the term of placing it and a reality that advertising effectiveness differs depending on the time period of transmitting the advertising information to the user has not been reflected. For instance, in a case where the user tends to access a web page regarding information of a certain area at night rather than in the day time, it is more effective to provide the banner advertisement placed on the web page at night than in the daytime and it is reasonable to vary the advertisement charges corresponding thereto. However, the advertisement charges have been conventionally fixed and it has been a problem that the operation cannot be effectively carried out for both of an advertisement provider and a web page provider (for example, provider, etc.).

Moreover, in a case where a fee is charged for advertising information provided to the user because the information is considered an important service for the user, it has been known that the value of the advertising information varies depending on the time when it is provided to the user; however, conventionally, such variation of the value has not been reflected in the charges, and more flexible and effective operation is desired.

### SUMMARY OF THE INVENTION

In view of the above mentioned problem, the invention has been accomplished. It is one object of the invention to provide a system and a method capable of collecting advertising information more efficiently and providing the advertising information to a user efficiently.

In order to accomplish the above and/or other objects, an information providing system of a first aspect of the invention comprises a server computer connected to the communication network, transmitting an advertisement through a communication network and varying advertisement charges according to time of transmitting the advertisement. The advertisement charges are varied according to the transmitting time, that is, timing of transmitting the advertising data through the communication network from the server computer instead of fixing the advertisement charges, whereby it is possible to effectively collect the advertising data from an advertisement provider and provide the collected data to the user. The transmission from the server throught the communication network may be carried out at the request of the user or without the request of the user.

The server computer herein preferably transmits the advertising data in which the advertisement charges are varied according to the number of accesses throught the communication network. A large number of accesses means that the advertising data can be provided to a great number of users and the value or the effectiveness of the advertisement is high. Thus, the advertisement charges are varied according to the number of accesses, more specifically, the advertisement charges are raised as the number of accesses becomes larger, whereby it is possible to collect the advertising data efficiently.

Moreover, it is preferable to link the advertising data with map data and change the advertisement charges according to the linked area. By placing the advertising data on the map data, the user can efficiently learn the advertising data of the area in which he or she is interested; however, the value of the advertisement in this area may differ depending on the kind of the advertisement or the like. For example, in a certain area, there is a case where the user wants more information regarding a specific shop, e.g., advertising data related to restaurants. Thus, the advertisement charges change according to the area linked with the advertising data, whereby it is possible to collect and provide the advertising data more efficiently to the user.

Moreover, the advertisement charges preferably vary according to advertisement space for the advertising data. More specifically, it is desirable to increase the advertisement charges as the advertisement space increases.

Moreover, the server computer preferably varies the advertisement space according to the number of accesses from the client computer. The number of accesses indicates how much the user is interested, and the advertisement space is varied according to the degree of the user's interest, more specifically, the advertisement space is enhanced as the number of accesses increases, whereby the advertising data can be more effectively provided to the user and the user can easily obtain the advertising data.

Moreover, an information providing system according to a second aspect of the invention comprises a first computer connected to a communication network and a server computer which transmits advertising data to the first computer at the request of the first computer and sends the first computer accounting data according to the transmitting time of the advertising data to the first computer. Charges are varied according to the transmitting time of the advertising data to the user, that is, timing of transmitting from the server computer at the request of the user, whereby the advertising data can be effectively provided to the user.

In the server computer herein the accounting data is preferably varied according to the number of requests from the first computer. As the number of the requests (the number of accesses) from the user increases, the advertising data attracts more interest and becomes valuable as information; therefore, the advertisement can be economically provided by varying charges according to the number of the requests.

Moreover, in an information providing method according to a third aspect of the invention, an advertisement charge table set according to time of providing the advertising data is provided, the advertising data is received based on the advertisement charge table, and the received advertising data is provided through the communication network.

The advertisement charges set according to the providing time rather than the fixed advertisement charge enable to efficiently collect the advertising data. Incidentally, the advertisement charge table may be stored in the computer as electronic data or may be corporealized as a visible medium, for example, paper.

Moreover, the advertisement charge table is preferably set according to the providing time and the number of accesses.

In addition, the advertisement charge table may be set according to the area for which the advertising data is placed.

Moreover, in an information providing method according to a fourth aspect of the invention, a request of transmitting advertising data is received through a communication network, the advertising data is transmitted to a computer requesting the transmission through the communication network, and the accounting data is transmitted to the one requesting for the transmission based on an accounting table set according to time of providing the advertising data.

There is an economical advantage for both of an advertisement provider and the user by charges set according to the time of providing instead of a fixed rate. Incidentally, the charge table may be stored in a computer as electronic data, and suitably presented to the user.

Moreover, the charge table is preferably set according to a number of requests for transmission.

Incidentally, the communication network in the invention may be either fixed-line or wireless and may be either public circuit or private circuit.

A server computer of a first aspect of the invention provides an information to a first computer through a communication network. The server computer comprises a memory that stores an advertisement data and a controller that transmites the advertisement data to the first computer through the communication network. The server computer sets an advertisement for transmitting the advertisement data which is charged to provider who provides the advertisement data, and sets the advertisement rate according to a transmitting time of the advertisement data. The advertisement charges are varied according to the transmitting time, that is, timing of transmitting the advertising data through the communication network from the server computer instead of fixing the advertisement charges, whereby it is possbile to effectively collect the advertising data from an advertisement provider and provide the collected data to the user.

### BRIEF DESCRIPTION OF THE DRAWINGS

The invention will be described in conjunction with the following drawings in which like reference numerals designate like elements and wherein:

FIG. 1 is a schematic view of the system of an embodiment of the invention;

FIG. 2 is an explanatory view showing a display screen of map and advertising data;

FIG. 3 is a diagram showing a relationship between time and advertisement charges;

FIG. 4 is a table showing another relationship of time, area, and advertisement charges;

FIG. 5 is a diagram showing a relationship of time, the number of accesses, and advertisement charges;

FIG. 6 is an explanatory view showing variation of advertisement space;

FIG. 7 is a diagram showing a relationship between time and user charges;

FIG. 8 is a table showing another relationship between time and user charges; and

FIG. 9 is a table showing a relationship between the number of accesses and placing charges of web page.

### DETAILED DESCRIPTION OF PREFERRED EMBODIMENT

Hereinafter, an embodiment of the invention will be explained based on the drawings.

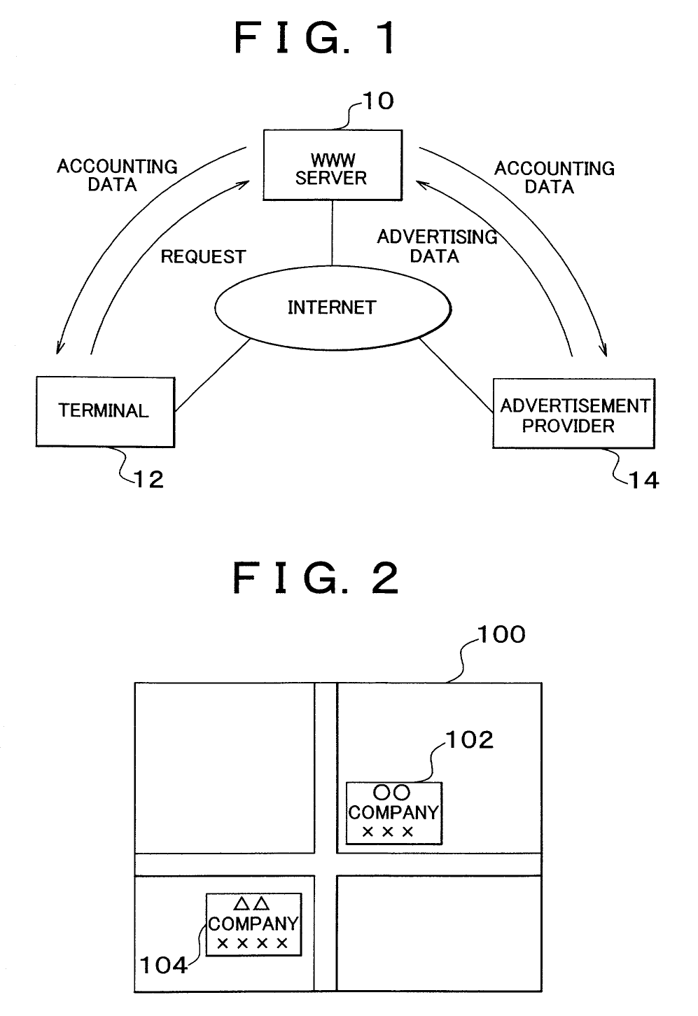

FIG. 1 shows a schematic view of a system according to an embodiment of the invention. A WWW (World Wide Web) server 10, a user terminal 12 and an advertisement provider terminal 14 are connected to each other through a communication network such as the Internet. Advertising data supplied from the advertisement provider besides map data is stored in the WWW server 10. The advertising data which is linked with a specific area in the map data is stored and the advertisement provider may designate the data to be linked with an area. The map data and the advertising data are written for example in HTML (Hypertext Markup Language) and stored in web page format. As a method for linking an area in the map data with the advertising data, a method in which the advertising data is laid together on the basis of a road map in a montage-like manner may be employed, for instance, with the road map being the first layer, advertising data related to hospitals being the second layer, advertising data related to hotels being the third layer, advertising data related to shops being the fourth layer and advertising data of movies being the fifth layer. As a display form of the advertising data, it is considered that an icon of the facility is indicated and information regarding the facility is displayed besides the icon and so on. Of course, it may be displayed in a banner manner at an arbitrary position on a web page. A URL (Universal Resource Locator) address is uniquely assigned to a web page of the map data to which the advertising data is appended, and the corresponding web page is transmitted to the user terminal 12 from the WWW server 10 at the request of the user terminal 12 with HTTP (Hypertext Transfer Protocol) protocol.

Although the advertising data stored in the WWW server 10 is supplied through the communication network from the advertisement provider terminal 14, it may be supplied “on-line” without going through the communication network. In a case where the advertising data is received from the advertisement provider, the WWW server 10 receives the advertising data based on advertisement charges set according to transmitting time of the advertising data to the user terminal 12. That is, the advertisement charges of the advertising data placed on the web page differ depending on the transmitting time in this embodiment. In other words, it can be said that lease charges for giving advertisement space for a web page on lease to the advertisement provider vary depending on the lease timing. After transmission of the advertising data is completed, or at predetermined timing during the term of advertising, the WWW server 10 transmits accounting data to the advertisement provider or the advertisement provider terminal 14. In the accounting data the calculation is based on the transmitting time (or time period) of the advertising data.

Moreover, the user may receive a desirable web page from the WWW server 10 by operating the user terminal 12, display on the terminal with a web browser or the like, and view the advertising data regarding a specific area.

FIG. 2 shows an example of map data and advertisements related to an area which are displayed on the user terminal 12. Advertisements 102,104 are displayed with icons of shops or the like in a map screen 100. The advertisements may be displayed when the user clicks the icons.

In a case where the advertisement provider or the WWW server side wishes, a fee may be charged for advertising data. When the user displays the pay advertising data on the terminal 12, the WWW server 10 transmits the accounting data to the user terminal 12. This accounting data is also set according to the transmitting time of the advertising data.

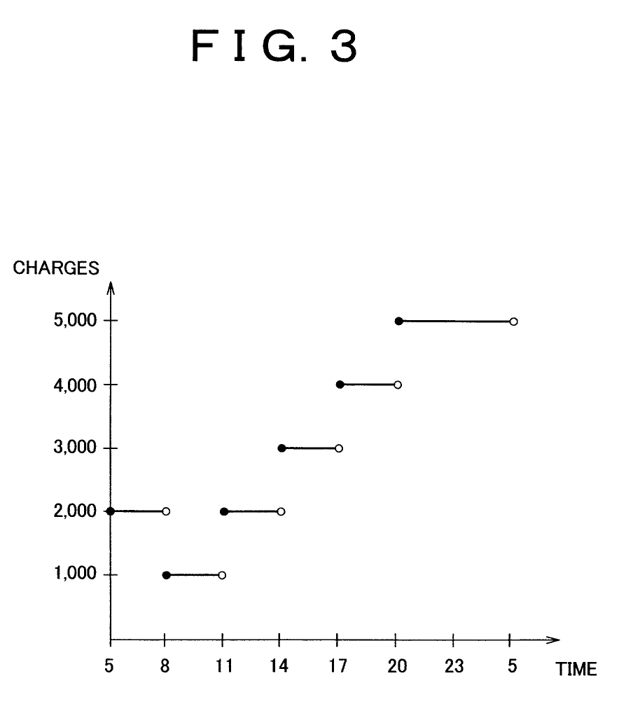

FIG. 3 shows examples of advertisement charges in receiving the advertising data from the advertisement provider. In the diagram, the horizontal axis is transmitting time (or time period) of the advertising data to the user terminal 12, plotted for 24 hours of 5-12-0-5. The vertical axis is advertisement charges. The diagram shows 2000 yen from 5 to 8, 1000 yen from 8 to 11, 2000 yen from 11 to 14, 3000 yen from 14 to 17, 4000 yen from 17 to 20, and 5000 yen from 20 to 5 are charged, respectively. The advertisement provider can easily judge which time period the advertising data is efficiently provided in view of the system of advertisement charges. The relationship between time and the advertisement charges in FIG. 3 is stored as a table in the WWW server 10 and it is preferable that the advertisement provider can suitably refer to it with the terminal 14. Moreover, in a case where the advertising data is supplied from the advertisement provider, the WWW server 10 may calculate the advertisement charges from the transmitting time of the advertising data to the user terminal and the stored table and transmit it to the advertisement provider. Of course, the side of the WWW server may hold and suitably show the table showing the relationship between the time and the advertisement charges as shown in FIG. 3 in a visible form (for example on paper or on a screen) and receive the advertising data.

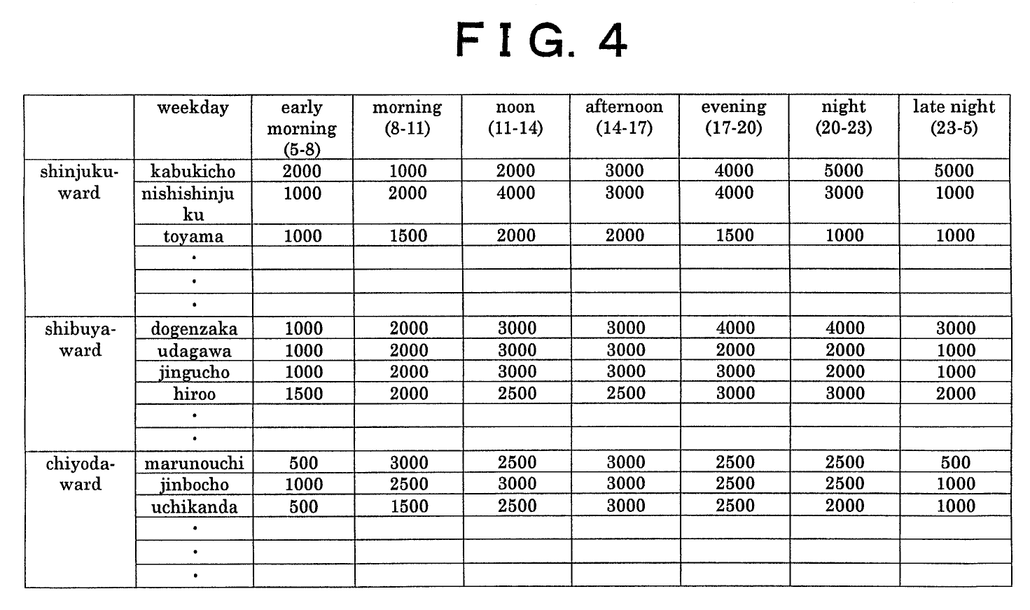

FIG. 4 shows another example of advertisement charges when advertising data is received from the advertisement provider. In this example, the advertisement charges change according to time (or time period) and they also vary depending on the area related to the advertising data, that is the area for which the advertising data is placed. For example, while 500 yen from 5 to 8 and 3000 yen from 8 to 11 are respectively charged for advertising data placed for Marunouchi, Chiyodaward, they vary to 1000 yen from 5 to 8 and 2500 yen from 8 to 11 for advertising data placed for Jinbocho, Chiyoda-ward. Thus, the advertisement charges are changed according to the area, whereby the advertising data can be received more efficiently.

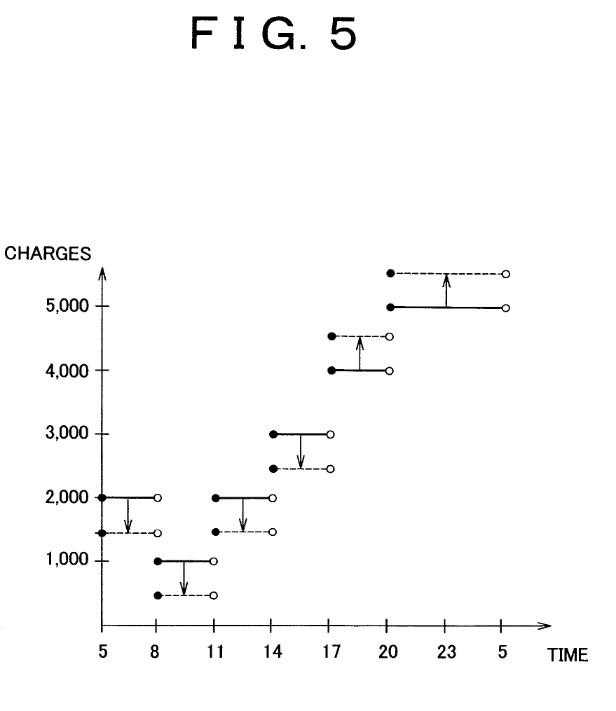

FIG. 5 shows still another example of advertisement charge when advertising data is received from the advertisement provider. In this example, the advertisement charges change according to time (or time period) and also depending on the number of accesses to the advertising data from the user. The number of accesses can be counted by an access counter within the WWW server 10, and the advertisement charges are changed based on the counting results. As a method for changing, for example, a lower threshold and an upper threshold are set and in a case where the number of accesses from the user does not reach the lower threshold, basic charges (the basic charges are to be the advertisement charges shown in FIG. 3) are reduced by 500 yen. On the contrary, in a case where the number of accesses from the user exceeds the upper threshold, the basic charges are raised by 500 yen, and so on.

In FIG. 5, the basic advertisement charges are shown by solid lines and the advertisement charges after being changed according to the number of accesses are shown by the dotted linen. The charge of 2000 yen is reduced to 1500 yen from 5 to 8 and the charge of 1000 yen is reduced to 500 yen from 8 to 11. Moreover, the charge of 2000 yen is reduced to 1500 yen from 11 to 14 and the charge of 3000 yen is lowered to 2500 yen from 14 to 17. On the other hand, the charge of 4000 yen is raised to 4500 yen from 17 to 20 and the charge of 5000 yen is raised to 5500 yen from 20 to 5.

In general, the basic charges are set to the most suitable amounts by statistically processing the number of accesses in the past, user's taste and so on; however, there may be a case where the basic charges are not always reasonable with the passage of time. Therefore, increase and decrease of the advertisement charges are adjusted according to the number of accesses, whereby more suitable advertisement charges can be set, which are efficient for both the advertisement provider and the side of the WWW server.

Incidentally, for example, in a case where the advertising data from the advertisement provider is displayed in banner format at an arbitrary position of a web page, if contents of the web page where the advertising data is placed are good, more users tend to access the web page; therefore, the number of accesses to the advertisement also increases. That is, the number of accesses to the advertising data influences the contents of the web page. Accordingly, in a case where accounting data in which the advertisement charges increase as the number of accesses increases is created, for a provider of the web page where the advertising data is placed, the accounting data in which placing charges of the web page (advertisement charges of the web page) are lowered according to the number of accesses is created and transmitted to the web page provider.

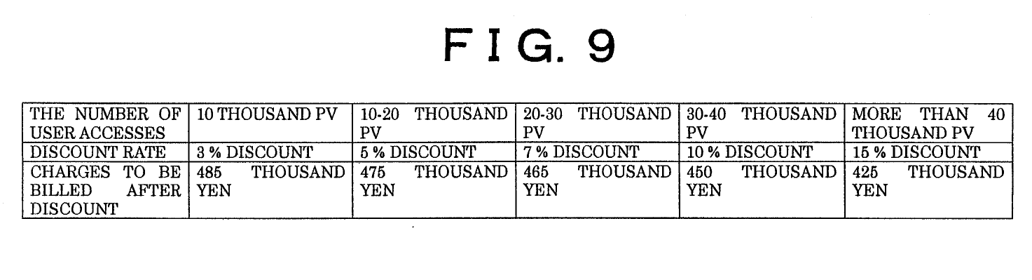

In FIG. 9 such an example of the accounting data to the web page provider according to the number of accesses is shown. In FIG. 9, in a case of the number of user accesses being 10 thousand PV (page view), 3% of discount is applied corresponding to the increase rate of the advertisement charges to the advertisement provider, and in a case of the number of user accesses being 40 thousand PV, 15% of discount is similarly applied corresponding to the increase rate of the advertisement charges to the advertisement provider. Suppose that the basic charges for placing a web page for one week are 500 thousand yen, web page placing charges amount to 485 thousand yen in the case of the number of user accesses being 10 thousand PV in the WWW server 10 and the web page placing charges become 425 thousand yen in the case of more than 40 thousand PV. In FIG. 9, discount rates of the advertisement charges in the number of user accesses other than those are shown. Thus, by adjusting the web page placing charges according to the number of accesses, an incentive to create better contents is given to the web page provider.

Incidentally, it is preferable to change the increase and decrease of the advertisement charges according to the number of accesses, and also to change advertisement space on a web screen according to the number of accesses. The great number of user accesses means that interest of the user is high to that extent. Therefore, an outstanding display of the advertisement within the page is an advantage for both the advertisement provider and the user.

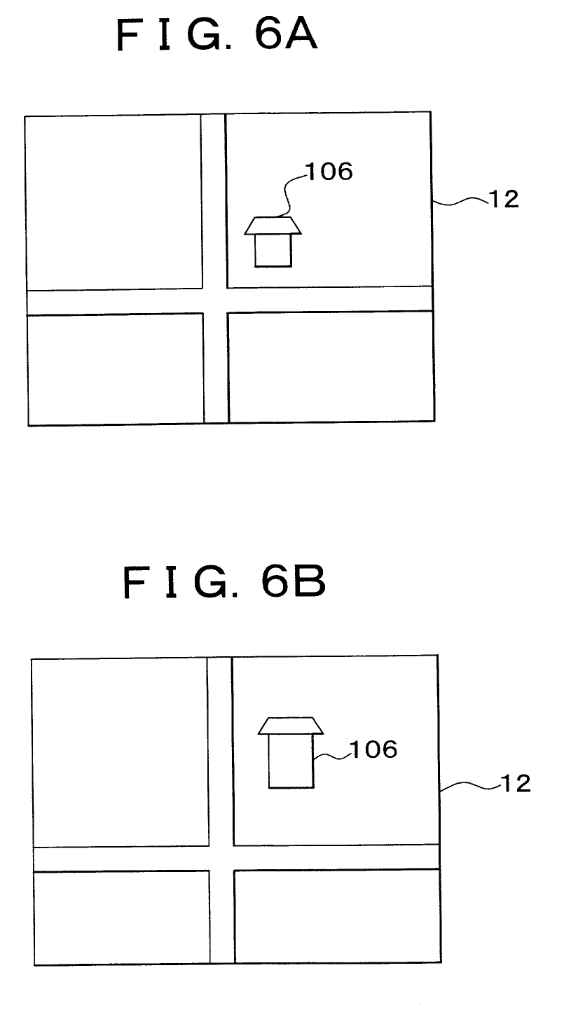

FIG. 6A and FIG. 6B show examples of screens displayed at the user terminal 12 when advertisement space is changed according to the number of accesses. FIG. 6A shows an example of screen in the initial state with an icon 106 of an advertisement in a standard size. Moreover, FIG. 6B shows an example of screen when the number of accesses from the user exceeds the upper threshold, the icon 106 of the advertisement which is magnified compared to that of FIG. 6A is displayed. Thereby, the advertisement provider is able to appeal one's advertisement to the user, and also the user can easily view the advertisement of interest within the page. Incidentally, it is possible to increase the advertisement space relative to the number of accesses. When the advertisement charges are changed according to the number of accesses, the advertisement charges can be calculated on the basis of the advertisement space changed according to the number of accesses. Specifically, for example, the original advertisement space is doubled in a case where the number of accesses exceeds the upper threshold, and the advertisement charges are increased by 50% by doubling the advertisement space and so on.

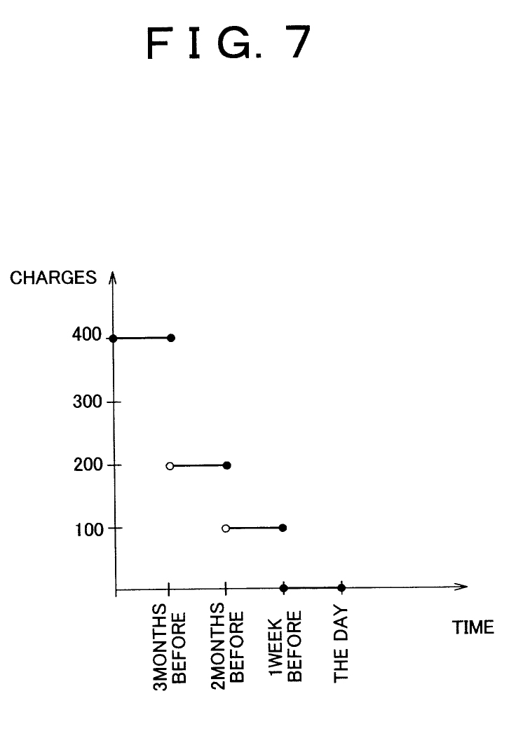

FIG. 7 shows an amount charged to the user terminal 12 by the WWW server 10 in a case where the user requests a desirable web page from the WWW server 10 and views an advertisement. Examples to be considered as being billable are shop information tied up with information magazines, event information tied up with shops, part-time job information, real estate information, auction participation, and bidding system (for example, a system enabling a user to make a reservation of a desired hotel in which a user presents a condition of staying at a latenight hotel at a cost of less than 10000 yen and an advertisement providing hotel nearby suggests a room meeting this condition).

As shown in FIG. 7, data for which a fee is charged to the user also changes according to transmitting time of the advertising data to the user. There is a case in which the value of information is lowered with the passage of time; for example, the earlier sales information of a certain shop is, the more valuable it is for the user (if the information is obtained in the middle of the sales, there may be a case that a good of interest has been sold out). Thus, for example, 400 yen is charged three months before an event or the like, 200 yen, 100 yen are charged for 3-2 months before and 2 months to 1 week before, respectively, and it costs nothing for one week before to the date. Thus, the charges are lowered with the passage of time, whereby what the advertisement provider (the seller) wants to sell, for example, sports, plays, musicals, tickets of concerts, reservation of vacant rooms of a late-night hotel, and so on, can be positively sold. Moreover, it is an advantage for the user who wants information at the lowest cost possible.

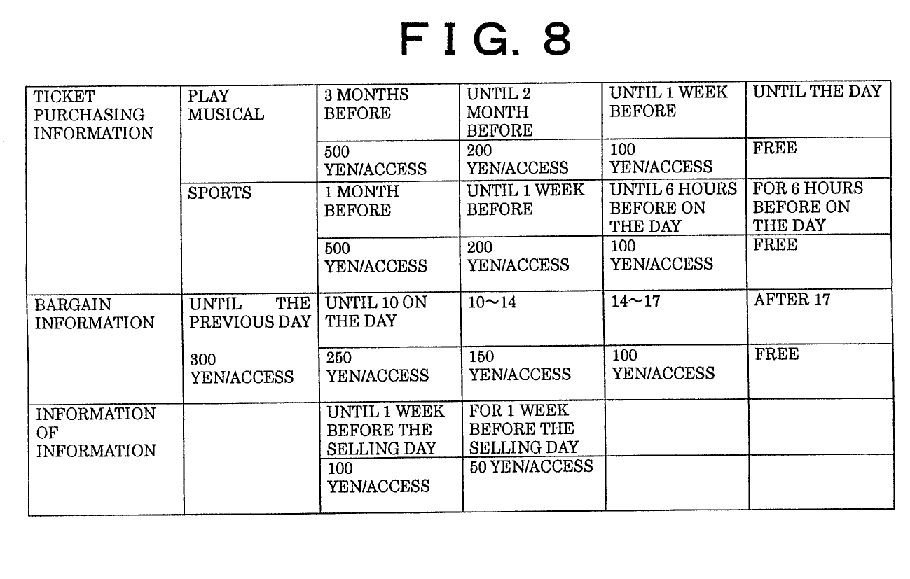

FIG. 8 shows another example of the accounting data transmitted to the user terminal 12. The WWW server 10 where such a table is stored calculates charges from the kind of advertising data requested by the user and time of the request (that is the transmitting time of the advertising data to the user terminal 12) based on the table and transmits it to the user terminal 12 as the accounting data. As kinds of advertising data, there are ticket purchasing information, bargain (sales) information, information of information magazines and so on. For example, as to the bargain information, charges are 300 yen/access (300 yen per one access) for the previous day, 250 yen/access until 10 of the day, 150 yen/access until 14 of the day, 100 yen/access until 17 of the day, and free after 17 o'clock of the day. Of course, in the drawing, it is also preferable to adjust increase and decrease of the basic charges according to the number of accesses.

While an embodiment of the present invention has been described, the invention is not limited to this embodiment, and various changes may be made thereto. For example, in the embodiment, a computer is depicted as the user terminal 12; however, it may be an arbitrary apparatus, may be PDA (Personal Digital Assistant) or a portable phone as long as it is capable of receiving the transmitted advertisement.

Moreover, the user terminal 12 may be installed to a vehicle and advertising data may be displayed on a screen, for example, of a vehicle navigation system. In such a case, the advertising data is transmitted to a terminal of each vehicle from an information center of the navigation system.

As explained in the foregoing, in the present invention advertisement charges or charges billed to the user are not fixed, but vary according to time; therefore, it is possible to efficiently collect the advertising data and provide the same to the user.

In the illustrated embodiment, the server computer 10 is implemented as a programmed general purpose computer. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. An information providing system comprising:
a server computer capable of transmitting an advertisement data through a communication network; wherein an advertising rate for transmitting the advertisement data is charged to a provider who provides the advertisement data to the server computer, and the advertising rate varies according to a transmitting time of the advertisement data.

2. The system according to claim 1, wherein the advertising rate varies according to a number of accesses to the advertising data through the communication network.

3. The system according to claim 2 wherein the advertising data is displayed on a web page, a placing charge for placing contents on the web page is charged to the provider who provides the contents to the server computer, and the advertising rate is raised as the number of accesses increases, and the placing charge is lowered as the number of accesses increases.

4. The system according to claim 1 wherein the advertising data is displayed on a web page, and the advertising rate varies according to an advertisement space on the web page.

5. The system according to claim 4 wherein the server computer changes the advertisement space according to a number of accesses to the advertising data through the communication network.

6. The system according to claim 1 wherein the advertising rate varies according to a location for which the advertising data is provided.

7. An information providing system comprising:
a server computer connected to a communication network and transmitting advertising data to a first computer at the request of the first computer and sending the first computer accounting data according to transmitting time of the advertising data to the first computer.

8. The system according to claim 7 wherein the server computer changes the accounting data according to a number of requests for transmitting the advertising data.

9. An information providing method comprising:
receiving advertising data from an advertisement provider, providing the advertising data through a communication network, and setting an advertising rate charged to the advertisement provider according to a providing time of the advertising data through the communication network.

10. The method according to claim 9 wherein the advertising rate is set according to the providing time and a number of accesses of the advertising data through the communication network.

11. The method according to claim 9 wherein the advertising rate is set according to an area for which the advertising data is provided.

12. The method according to claim 9 further comprising:
displaying the received advertising data on the web page, increasing the advertising rate charged to the advertisement provider as a number of accesses of the advsertising data through the communication network increases, and lowering a displaying charge charged to the advertisement provider as the number of accesses increases.

13. An information providing method comprising:
providing an advertising rate table set according to a providing time of advertising data, receiving the advertising data at an advertising rate set based on the advertisement rate table, and providing the received advertising data through a communication network.

14. An information providing method comprising:
receiving a request for transmitting advertising data through a communication network and transmitting the advertising data to a computer requesting for the transmission through the communication network, and sending accounting data set according to a providing time to the computer requesting the transmission.

15. The method according to claim 14, wherein the accounting data is set according to a number of requests for the transmission.

16. A server computer providing an information to a first computer through a communication network, comprising:
a momory that stores an advertisement data; and
a controller that transmites the advertisement data to the first computer through the communication network, and sets an advertisement rate for transmitting the advertisement data which is charged to a provider who provides the advertisement data, wherein the controller sets the advertisement rate according to a transmitting time of the advertisement date.

17. Tha server computer according to claim 16, wherein the controller sets the advertisement rate according to a number of accesses to the advertising data through the communication network.

18. The server computer according to claim 17, wherein the advertisement data is displayed on a web page, and the controller sets a placing charge for placing contents on the web page which is charged to the provider who provides the contents of the web page, and the controller raises the advertisement rate as the number of accesses increases, and lowers the placing charge as the number of accesses increases.

19. The sever computer according to claim 16, wherein the controller sets the advertisement rate according to a location for which the advertisement data is provided.

20. The server computer according to claim 16, wherein the controller sets an advertisement space displaying the advertising data according to a number of accesses to the advertising data from the first computer.
